(19) United States
(12) Patent Application Publication
(10) Pub. No.: US 2007/0124014 A1
(43) Pub. Date: May 31, 2007

(54) Apparatus and method for processing analog encoder signals

(75) Inventor: Tae-Young Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/520,675

(22) Filed: Sep. 14, 2006

(30) Foreign Application Priority Data
Nov. 17, 2005 (KR) 10-2005-0110128

(51) Int. Cl. G06F 19/00

(52) U.S. Cl. 700/170

(57) ABSTRACT

An apparatus and a method for processing signals of an analog encoder for generating quadrature signals to control a rotation of a motor using the analog encoder are provided. The apparatus for processing signals of the analog encoder includes a pattern generation unit of the analog encoder generating an encoder waveform corresponding to a waveform of the output signals by receiving the output signal of the analog encoder including at least one channel and sampling the received signals at regular intervals, and a generation unit for generating a status lookup table receiving the encoder pattern and generating the status lookup table including a predetermined number of information pieces on the encoder status based on the received encoder pattern, wherein the quadrature signals are generated by comparing feedback output signals to the information on the encoder status. The apparatus is adaptable to characteristics of various encoders.

### CROSS-REFERENCE TO RELATED PATENT APPLICATION

This application claims the benefit of Korean Patent Application No. 10-2005-0110128, filed in the Korean Intellectual Property Office on Nov. 17, 2005, the entire disclosure of which is hereby incorporated by reference.

### BACKGROUND OF THE INVENTION

1. Field of the Invention

The present invention relates to an apparatus and a method for processing analog encoder signals. More particularly, the present invention relates to an apparatus and a method for generating a quadrature signal to control a motor in which an analog pseudo sine wave output signal output from an analog encoder is divided into regions and sampled, and a predictive current status is determined using a current position of the analog encoder and status information on a positional change which has been obtained from comparing the latest status including information on a precise position in a period to a current output of the analog encoder.

2. Description of the Related Art

As automatic control systems have been rapidly developed recently, the importance of processing signals which have been output from a variety of sensors is growing steadily.

FIG. 1 is a block diagram of a conventional apparatus for calculating a position of an encoder. The apparatus includes an analog encoder 100, a generation unit 110 for generating quadrature signals, an inverter 120, a multiplexer 130, an analog/digital converter 140, and a calculation unit 150 for calculating absolute positions.

Referring to FIG. 1, the analog encoder 100 which is connected to an axis of a motor rotates together with the motor and outputs a predetermined number, for example, two, of pseudo sine wave signals having a relative phase difference of 90 degrees per each revolution of the analog encoder 100.

The generation unit 110 which is connected to an output terminal of the analog encoder 100, receives a pseudo sine wave output signal from the analog encoder 100 as an input and generates a quadrature signal to obtain information on a coarse position for dividing a period of the output signal into a plurality of states.

The inverter 120 inverts the output signal from the encoder 100.

The multiplexer 130 receives the pseudo sine wave output signal which has been output from the analog encoder 100 and the inverted output signal and outputs one signal only based on the information on the coarse position.

The analog/digital converter 140 converts the output signal from the multiplexer 120 from an analog signal into a digital signal and transmits the digital signal to the calculation unit 150 for calculating absolute positions.

The calculation unit 150 receives the digital signal which has been output from the analog/digital converter 140 and the quadrature signal which has been output from the generation unit 110 and calculates a precise position of the analog encoder 100 using the information on the coarse position obtained from the quadrature signal and the information on a precise position from the converted digital signal.

However, according to the conventional technology, the analog/digital conversion values must be read at short intervals for precise control, thus putting a heavy load on a central processing unit (CPU).

In addition, the output signal of the analog encoder 100 is assumed to have predetermined characteristics. For example, two output signals of the analog encoder 100 may be assumed to have a relative phase difference of 90 degrees between each other. However, characteristics of analog encoders are different from one encoder to another. For example, signals generated from analog encoders may have different phase differences between one another. Furthermore, analog encoders produced using the same manufacturing process inevitably have differences due to process variations. In addition, characteristics of the same analog encoder may change over time.

If the characteristics of the analog encoder 100 vary as described above, control efficiency of the analog encoder 100 decreases.

Accordingly, technology capable of performing adaptive controlled operations according to a change in characteristics of the analog encoder 100 is necessary.

### SUMMARY OF THE INVENTION

Exemplary embodiments of the present invention provide an apparatus and a method for generating a quadrature signal to control a motor in which an analog pseudo sine wave output signal output from an analog encoder is divided into predetermined regions, sampled, and compared to the output signal of the analog encoder to determine a predictive current status, that is a next status, from a latest status.

In addition, exemplary embodiments of the present invention facilitate generation of a quadrature signal or obtaining positional information without using an analog-to-digital converter which is used in a conventional apparatus.

Exemplary embodiments of the present invention also provide an apparatus and a method for processing signals of an analog encoder capable of being adapted to different analog encoders by automatically generating a pattern of the analog encoder and a status lookup table corresponding to characteristics of the encoder.

According to an exemplary aspect of the present invention, there is provided an apparatus for processing an analog encoder signal, comprising an analog encoder and generating quadrature signals for controlling rotation of a motor. The apparatus also comprises: a pattern generation unit of the analog encoder receiving an output signal of the analog encoder comprising at least one channel, generating an encoder pattern corresponding to a waveform of the output signal and sampling the received output signal at predetermined intervals; and a generation unit for generating a status lookup table receiving the encoder pattern and generating the status lookup table comprising information on a predetermined number of statuses based on the received encoder pattern. The quadrature signals are generated by comparing feedback output signals to the status information.

In an exemplary implementation of certain embodiments of the present invention, the apparatus may further comprise: a pattern storage unit of the analog encoder storing the encoder pattern received from the generation unit and outputting a pattern value of the analog encoder corresponding to latest status information received from a latch unit for storing a latest status; and a comparison unit generating status information on positional change by comparing the pattern value of the analog encoder to the output signal of the analog encoder. The latch unit may be implemented to set the latest status to a predictive current status transferred from a determination unit for determining the current status according to a reference clock. The determination unit may be implemented to determine the predictive current status using the status information based on the status information on positional change and the latest status information.

In an exemplary implementation of certain embodiments of the present invention, the apparatus may further comprise a digital-to-analog converter converting an output of the pattern storage unit of the analog encoder into an analog signal and transferring the converted analog signal to the comparison unit.

In an exemplary implementation of certain embodiments of the present invention, the pattern generation unit of the analog encoder may comprise: a characteristic value extraction unit extracting characteristic values comprising a maximal value and a minimal value and calculating a median value using the extracted maximal and minimal values; a period calculation unit calculating a period of the output signal using the characteristic values; and a start position extraction unit extracting a start position of a period using the characteristic values. The encoder pattern is generated by sampling a waveform corresponding to one period from the start position at a sampling rate.

In an exemplary implementation of certain embodiments of the present invention, the period calculation unit may sequentially extract a first position which has a smaller value than the median value, a second position which has a value equal to or greater than the median value, a third position which has a value smaller than the median value, and a fourth position which has a value equal to or greater than the median value. One period may be determined to be from the second position to the fourth position.

In an exemplary implementation of certain embodiments of the present invention, the start position extraction unit may have the output signals corresponding to the channels smaller than the median value. The start position is determined to be a position having a minimal difference value of the output signals.

In an exemplary implementation of certain embodiments of the present invention, the apparatus may further comprise a driving signal conversion unit converting the predictive current status or the latest status into the quadrature signals. The driving signal conversion unit comprises a gray code conversion unit converting the predictive current status or the latest state into a gray code and generating the quadrature signals.

In an exemplary implementation of certain embodiments of the present invention, the status lookup table may represent a relationship between the predictive current status or the latest status and the driving signal, and the quadrature signals may be generated using the status lookup table.

According to another exemplary aspect of the present invention, there is provided a method of processing signals of an analog encoder for generating quadrature signals to control a motor using output signals of the analog encoder comprising at least one channel. The method comprises: generating an encoder pattern of the analog encoder by receiving an output signal of the analog encoder and sampling the output signal at a predetermined sampling rate; receiving the encoder pattern and generating a status lookup table comprising a predetermined number of information pieces of the analog encoder; and generating quadrature signals by comparing the feedback output signal to the status information.

In an exemplary implementation of certain embodiments of the present invention, the method may further comprise: storing the encoder pattern and outputting a pattern value of the analog encoder corresponding to a latest status of the analog encoder; generating status information on positional change by comparing the pattern value of the analog encoder to the output signal of the analog encoder; latching a predictive current status and setting the latest status to a predictive current status according to a reference clock; and determining the predictive current status using the status information based on the status information on positional change and the latest status.

In an exemplary implementation of certain embodiments of the present invention, generating quadrature signals may comprise: extracting characteristic values comprising maximal and minimal values of the output signal and calculating a median value using the extracted maximal and minimal values; calculating a period of the output signal using the characteristic values; and extracting a start position of a period using the characteristic values. The encoder pattern is generated by sampling a period of a waveform starting from the start position.

In an exemplary implementation of certain embodiments of the present invention, calculating a period of the output signal may comprise: sequentially extracting a first position which has a smaller value than the median value, a second position which has a value equal to or greater than the median value, a third position which has a value smaller than the median value, and a fourth position which has a value equal to or greater than the median value, and determining from position 2 to position 4 to be one period.

In an exemplary implementation of certain embodiments of the present invention, when extracting a start position of a period, the output signals corresponding to the channels may have values smaller than the median value, and the start position is determined to be a position having a minimal difference value of the output signals.

In an exemplary implementation of certain embodiments of the present invention, receiving the encoder pattern and generating a status lookup table may comprise: converting the analog encoder pattern into an analog signal; generating status information on positional change by comparing the converted analog signal and a pseudo sine wave output signal of the analog encoder; and determining the predictive current status which is the next status based on the generated status information on the positional change and the latest status of the analog encoder.

In the apparatus and method for analog encoder signals according to an exemplary embodiment of the present invention, an analog encoder pattern and a status lookup table corresponding to a characteristic of an analog encoder can be generated automatically.

According to an exemplary embodiment of the present invention, a computer readable medium is provided for storing thereon a plurality of computer executable instructions for processing signals and generating quadrature signals to control a motor using output signals of an analog encoder comprising at least one channel. The computer executable instructions may comprise a first set of instructions for generating an encoder pattern of an analog encoder by receiving an output signal of the analog encoder and sampling the output signal, a second set of instructions for receiving the encoder pattern and generating a status lookup table comprising at least one information item of the analog encoder, and a third set of instructions for generating quadrature signals by comparing the feedback output signal to the status information.

### BRIEF DESCRIPTION OF THE DRAWINGS

The above and other features and advantages of the present invention will become more apparent by describing in detail exemplary embodiments thereof with reference to the attached drawings in which like reference numerals will be understood to refer to like parts, components and structures, where:

FIG. 1 is a block diagram of a conventional apparatus for calculating a position of an encoder;

FIG. 2 is a block diagram of an apparatus for processing analog encoder signals according to an exemplary embodiment of the present invention;

FIG. 3 is a block diagram of an apparatus for processing analog encoder signals according to an exemplary embodiment of the present invention;

FIG. 4 is a simplified block diagram of the apparatus for processing analog encoder signals illustrated in FIG. 3, according to an exemplary embodiment of the present invention;

FIG. 5 is a flowchart illustrating a pattern generation stage of an analog encoder included in a method of processing analog encoder signals, according to an exemplary embodiment of the present invention;

FIG. 6 is a flowchart illustrating a generation stage of a status lookup table included in a method of processing analog encoder signals, according to an exemplary embodiment of the present invention;

FIG. 7 is a graph of output signals of the analog encoder according to an exemplary embodiment of the present invention; and

FIG. 8 is a status lookup table according to an exemplary embodiment of the present invention.

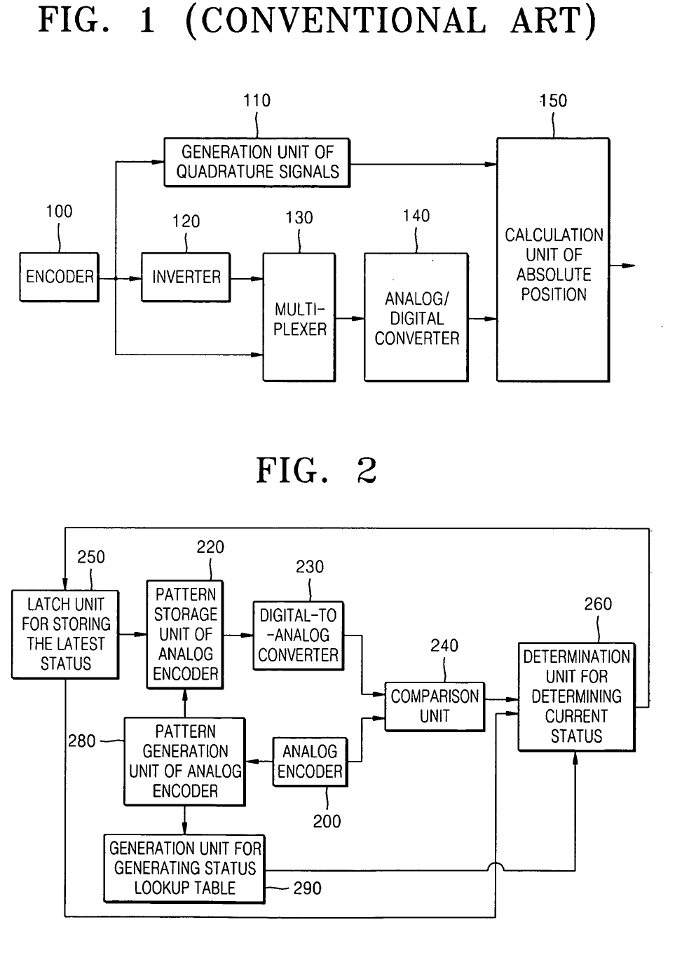

### DETAILED DESCRIPTION OF EXEMPLARY EMBODIMENTS

Hereinafter, exemplary embodiments of the present invention will be described in detail with reference to the attached drawings. FIG. 2 is a block diagram of an apparatus for processing analog encoder signals according to an exemplary embodiment of the present invention.

Referring to FIG. 2, the apparatus for processing the analog encoder signals includes an analog encoder 200, a pattern storage unit 220 of the analog encoder 200, a digital-to-analog converter 230, a comparison unit 240, a latch unit 250 storing a latest status, a determination unit 260 for determining a current status, a pattern generation unit 280 of the analog encoder 200, and a generation unit 290 for generating a status lookup table.

The analog encoder 200 which is connected to an axis of a motor rotates together with the motor and outputs a predetermined number, for example, two, of pseudo sine wave signals having a phase difference of 90 degrees between each other per each revolution. The pattern storage unit 220 of the analog encoder 200 stores a sampled pattern of the analog encoder 200, which is a result of sampling an output signal of the analog encoder 200. In addition, the pattern storage unit 220 of the analog encoder 200 outputs a pattern value of the analog encoder 200 corresponding to the latest status which has been input from the latch unit 250 storing the latest status. The digital-to-analog converter 230 converts the pattern value of the analog encoder 200 which has been received from the pattern storage unit 220 of the analog encoder 200 into an analog form.

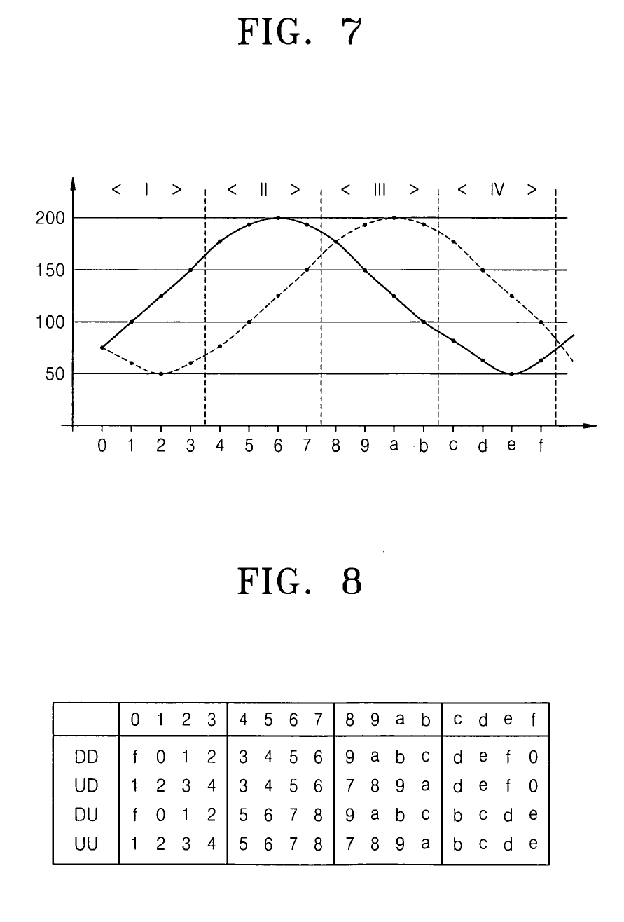

Then the comparison unit 240 generates status information on a positional change by comparing an output signal of the digital-to-analog converter 230 and the output signal of the analog encoder 200. The information on the positional change will be described later in detail with reference to FIGS. 7 and 8.

The status information on the positional change generated in the comparison unit 240 is transferred to the determination unit 260 for determining the current status. The determination unit 260 for determining the current status determines a predictive current status using an output signal of the comparison unit 240 and an output signal of the latch unit 250. The determined predictive current status is feedback to the latch unit 250. Then the latch unit 250 latches the predictive current status, which has been transferred from the determination unit 260 according to a reference clock, replaces the latest status with the predictive current status, and transfers the latched latest status to the pattern storage unit 220 of the analog encoder and the determination unit 260.

According to an embodiment of the present invention, a quadrature signal for controlling rotations of the motor is generated by feedback of pseudo sine wave output signals of the analog encoder as described above, so that the effect of outside disturbance is decreased and a precision rate of the analog encoder 200 is increased.

The pattern generation unit 280 of the analog encoder 200 illustrated in FIG. 2 generates a sampled pattern of the analog encoder by sampling feedback output signals including first and second pseudo sine wave output signals which have been output from the analog encoder 200 when the analog encoder 200 is initialized.

The pattern generation unit 280 of the analog encoder 200 can generate a more precise pattern of the analog encoder 200 by increasing a sampling rate thereof.

In addition, since the pattern generation unit 280 of the analog encoder 200 generates a pattern of the analog encoder 200 by automatically sampling the output signal of the analog encoder 200, the generated pattern of the analog encoder 200 is adapted to characteristics of the output signals corresponding to one or more channels. Accordingly, the precision rate of the apparatus for processing analog encoder signals according to an exemplary embodiment of the present invention can be increased. The pattern of the analog encoder 200 which has been generated in the pattern generation unit 280 is stored in the pattern storage unit 220 of the analog encoder 200. The pattern generation unit 280 of the analog encoder 200 will be described later in detail.

A driving signal for driving the motor is generated using the predictive current status or the latest status. A quadrature signal generating a maximal torque of the motor may be used as a driving signal of the motor. In addition, the driving signal may be generated by converting the predictive current status or the latest status into a gray code or using a lookup table which indicates a relationship between the predictive current status or the latest status and the driving signal.

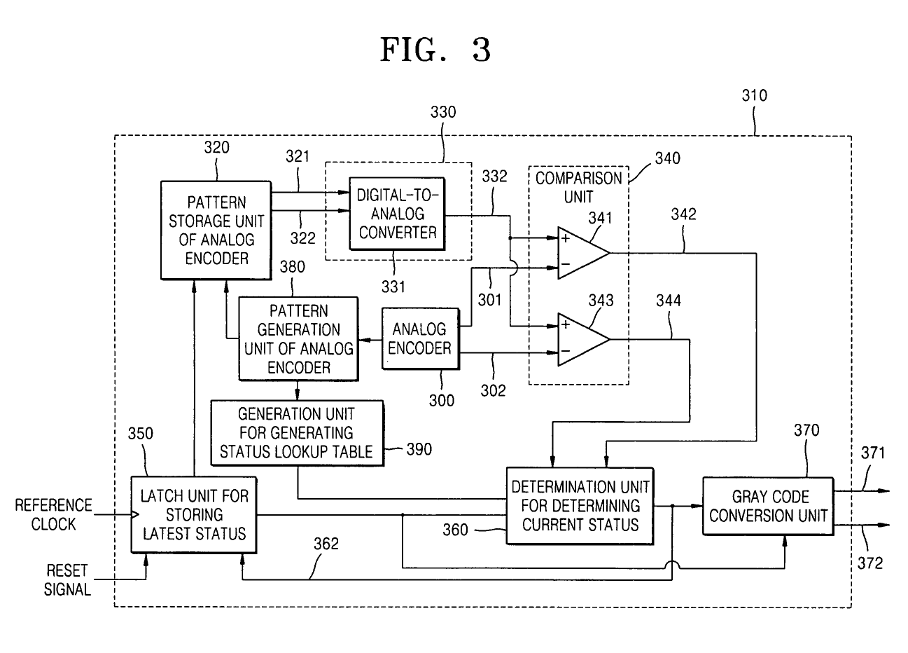

FIG. 3 is a block diagram of an apparatus for processing analog encoder signals according to an exemplary embodiment of the present invention.

The apparatus 310 for processing analog encoder signals illustrated in FIG. 3 includes a pattern storage unit 320 of an analog encoder 300, a digital-to-analog converter 330, a comparison unit 340, a latch unit 350 for storing a latest status, a determination unit 360 for determining a current status, a gray code conversion unit 370, a pattern generation unit 380 of the analog encoder 300, and a generation unit 390 for generating a status lookup table. The comparison unit 340 includes a first comparison unit 341 and a second comparison unit 343.

The pattern storage unit 320 of the analog encoder 300 stores sampled values of a first signal 301 and a second signal 302 which are output signals of the analog encoder 300 generated in an initialization stage. In addition, the pattern storage unit 320 of the analog encoder 300 transfers first and second digital pattern values 321 and 322 of the first and second signals 301 and 302 to the digital-to-analog converter 330 in synchronization with the latest status, when the latest status is input from the latch unit 350.

According to the current embodiment of the present invention, since a period of a signal which has been output from the analog encoder 300 is divided into 16 regions of 0 to f as illustrated in FIG. 7, sixteen sampled values are stored for the first signal 301 and the second signal 302, respectively. Although sine waves are illustrated in FIG. 7, real output signals of the analog encoder 300 are not sine waves, and the output signals are assumed to be sine waves for convenience of description.

The digital-to-analog converter 330 converts the first digital pattern value 321 which has been input from the pattern storage unit 320 of the analog encoder 300 into an analog signal and outputs the converted analog signal 332 to the comparison unit 340. Although the digital-to-analog converter 330 illustrated in FIG. 3 includes only one conversion unit 331, two or more conversion units 331 may be included in the digital-to-analog converter 330.

The comparison unit 340 receives the analog signal 332 of the digital-to-analog converter 300 and the first and second signals 301 and 302 of the analog encoder 300, compares relative magnitudes of the signals, and outputs digital signals Xup 342 and Yup 344 which contain status information on positional changes in a form of “1s” and “0s”.

The digital signal Xup 342 is output from the first comparison unit 341, and the digital signal Yup 344 is output from the second comparison unit 343. The digital signal 342 denotes status information on positional change of first comparison unit, and the digital signal 344 denotes status information on positional change of second comparison unit. The digital Xup and Yup signals, as the status information on the positional change (PCSI), are used together with the information on the latest status for predicting the next state, that is, a predictive current state.

The latch unit 350 receives the predictive current state that is an output signal of the determination unit 360 and inputs the predictive current state that has been stored for determining the next status to the determination unit 360 as a previous state. In addition, the latch unit 350 transfers the predictive current state that has been input to the determination unit of the current status 360 to the pattern storage unit 320 of the analog encoder 300 in synchronization with a reference clock. In addition, the status of the latch unit 350 is initialized according to a reset signal when the apparatus is initialized.

The determination unit 360 determines the predictive current state that is a state of the next position based on the state information on the positional change contained in the digital signals Xup 342 and Yup 344 received from the comparison unit 340 and the latest status received from the latch unit 350. The determination of the predictive current state will be described later with reference to FIGS. 7 and 8.

The pattern generation unit 380 of the analog encoder 300 generates an encoder pattern adapted to characteristics of the analog encoder 300. For the generation of the adapted encoder pattern, the pattern generation unit 380 of the analog encoder 300 extracts a maximal value and a minimal value of the first and second output signals 301 and 302 of the analog encoder 300 and calculates a median value using the extracted minimum and maximum values. In addition, a period of the first and second signals 301 and 302 is calculated using the extracted characteristic values and a start position of the period is extracted. The pattern generation unit 380 of the analog encoder 300 generates an encoder pattern by sampling a waveform corresponding to a period beginning from the start position at a predetermined sampling rate using the calculated period and the start position.

An example of the encoder pattern generated by the pattern generation unit 380 of the analog encoder 300 is illustrated in TABLE 1.

TABLE 1

| | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| X | 78 | 100 | 127 | 154 | 178 | 193 | 198 | 193 | 177 | 155 | 128 | 101 | 78 | 62 | 57 | 64 |
| Y | 77 | 61 | 55 | 60 | 76 | 99 | 126 | 153 | 176 | 192 | 197 | 192 | 176 | 153 | 126 | 99 |

In FIG. 7, a graph of the analog encoder pattern corresponding to TABLE 1 is illustrated.

As described above, the pattern generation unit 380 of the analog encoder 300 included in the apparatus for processing analog encoder signals according to an exemplary embodiment of the present invention generates an encoder pattern automatically using characteristic values of the analog encoder 300 which is currently in use, rather than using a fixed pattern value. Accordingly, encoder patterns adapted for different analog encoders 300 can be generated. The processes for calculating a period and extracting the start position in the pattern generation unit 380 of the analog encoder 300 will be described later in detail.

The generation unit 390 generates a status lookup table that represents a relationship between the predictive current status or the latest status and a driving signal. In other words, when the driving signal is applied, the relationship of the driving signal to the positional information of the analog encoder 300 is stored in the status lookup table. The positional information of the analog encoder 300 can be easily obtained using the status lookup table without complex calculation. The status lookup table generated by the generation unit 390 will be described later with reference to FIG. 8.

The gray code conversion unit 370 converts status information 362 received from the determination unit 360 or the latch unit 350 into a gray code and generates quadrature signals dX 371 and dY 372 using the converted gray code. For the generation of the quadrature signals dX 371 and dY 372, in the gray code conversion unit 370, a gray code table (not shown) that sets a relationship between a gray code and quadrature signals dX 371 and dY 372 may be included.

An example of the gray code table is shown in TABLE 1.

Instead of using the gray code conversion unit 370, a status information code including information on the quadrature signals may be stored in the determination unit 360, and the quadrature signals dX 371 and dY 372 may be generated using the status information code.

In TABLE 2, an example of status information, a status information code, and corresponding quadrature signals are shown. In Table 2, as an illustration, the status information includes only eight statuses for simplicity.

The quadrature signals corresponding to the gray code are not limited to the exemplary embodiments of the present invention and may be changed appropriately as needed.

TABLE 2

| EXAMPLE OF | | | |
|---|---|---|---|
| STATUS | | | |
| INFORMATION | BINARY | | QUADRATURE |
| USING | CODED | STATUS | SIGNALS (FIRST |
| DECIAML | DECIMAL | INFORMATION | AND SECOND |
| NUMBERS | CODE | CODE | SIGNALS) |
| 0 | 000 | 010 | 10 |
| 1 | 001 | 011 | 11 |
| 2 | 010 | 001 | 01 |
| 3 | 011 | 000 | 00 |
| 4 | 100 | 110 | 10 |
| 5 | 101 | 111 | 11 |
| 6 | 110 | 101 | 01 |
| 7 | 111 | 100 | 00 |

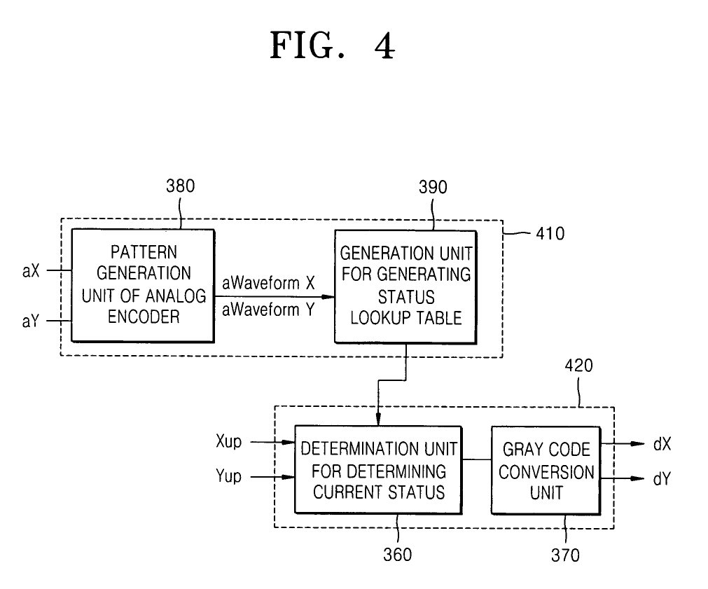

FIG. 4 is a generalized block diagram of an apparatus for processing analog encoder signals illustrated in FIG. 3, according to an exemplary embodiment of the present invention.

First, output signals aX and aY of the analog encoder 300 are applied to the pattern generation unit 380 of the analog encoder 300. Then, the pattern generation unit 380 generates encoder patterns aWaveformX and aWaveformY corresponding to the received output signals aX and aY and transfers the generated encoder patterns aWaveformX and aWaveformY to the generation unit 390 for generating the status lookup table. The pattern generation unit 380 and the generation unit 390 may be implemented in a form of firmware 410 in the apparatus. A user can easily change various user friendly environments including a sampling rate by implementing the pattern generation unit 380 and the generation unit 390 in the form of the firmware 410. The encoder patterns aWaveformX and aWaveformY have a form of an array having different dimensions based on resolution.

For example, when the resolution is 16, the encoder patterns aWaveformX and aWaveformY are implemented as arrays having 1×16 dimensions, respectively.

The generation unit 390 generates the status lookup table including encoder status information corresponding to a predetermined sampling rate of the received encoder patterns aWaveformX and aWaveformY. The generated status lookup table is transferred to the determination unit 360. As described above, the status lookup table represents a relationship between the predictive current status or the latest status and the driving signal. Accordingly, the determination unit 360 can obtain the positional information on the analog encoder 300 using the status lookup table without complex calculation when the driving signals Xup and Yup are applied.

The predictive current status determined in the determination unit 360 is transferred to the gray code conversion unit 370, and the gray code conversion unit 370 generates the quadrature signals dX 371 and dY 372 by converting the received predictive current status into a gray code. The quadrature signals dX and dY which have been converted into a gray code can be used in various apparatuses including the gray code conversion unit 370, and accordingly the apparatus for processing analog encoder signals according to the current embodiment of the present invention is compatible with other apparatuses.

As illustrated in FIG. 4, the determination unit 360 and the gray code conversion unit 370 may be implemented in a semiconductor array 420.

For example, the semiconductor array 420 may be a field-programmable gate array (FPGA). When a design using a semiconductor array 420 such as a FPGA is completed, semiconductor chips having permanent electronic circuits may be manufactured for improving performance of the determination unit 360 and the gray code conversion unit 370.

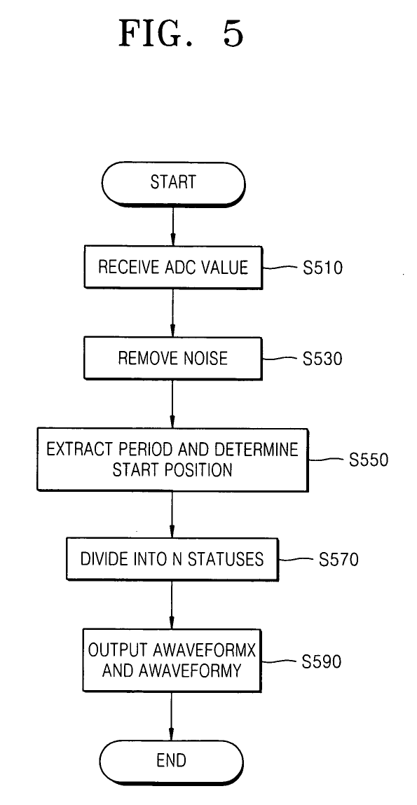

FIG. 5 is a flowchart illustrating a pattern generation stage of an analog encoder included in a method of processing analog encoder signals, according to an embodiment of the present invention.

At first, output signals which have been output while the analog encoder moves a predetermined distance are received (S510). The output signals are generated corresponding to X and Y channels of the analog encoder. The output signals are digital signals converted into digital values.

The received output signals are filtered for low band passing to remove noise (S530).

In addition, a period is extracted from the noise-removed signals and a start position is determined (S550). The extraction process will now be described in detail.

First, characteristic values, that are, maximal, minimal, and median values are extracted from the output signal of the X channel. After the characteristic values are extracted, a position having a value less than the median value, a position having a value equal to or greater than the median value, a position having a value less than the median value, and a position having a value greater than the median value are extracted sequentially, while the output signal of the X channel or the Y channel is scanned. Referring to FIG. 7, position 0 having a value less than the median value as a first position, position 1 having a value equal to or greater than the median value as a second position, and position c having a value less than the median value as a third position are extracted, and a position having a value greater than the median value is extracted from a waveform succeeding to the waveform in FIG. 7 as a fourth position.

When these positions are extracted, a part of the output signal which starts at the second position and ends at the fourth position is set as one period.

Although position 0 is shown as the first position having a value less than the median value in FIG. 7, position c of the waveform having a value less than the median value may alternatively be selected as the first position illustrated in FIG. 7. If position c is selected as the first position, the second to fourth positions are selected from the succeeding waveform to the waveform illustrated in FIG. 7. In any case, a part of the signal starting at the second position and ending at the fourth position is set as one period.

When one period of the output signal is determined, a start position is selected. At this time, a position at which the output signals of the X and Y channels which have values less than the median value and the most similar values with each other may be selected as the start position. In the output signals illustrated in FIG. 7, position 0 may be selected as the start position.

When the period and the start position are selected, corresponding voltage values are extracted by dividing a part of the output signal which starts at the start position and ends at a position corresponding to the end of the period by a sampling rate N (S570). At this time, the voltage values may be more precisely calculated using a method of interpolation as below.

After the period and the start position are selected, a part of the output signal from the start position to the position which has a time difference of one period from the start position is divided by a predetermined sampling rate N and a corresponding voltage value is extracted (S570). In an exemplary implementation, the voltage value may be calculated using a method of interpolation as shown below for more precise calculation.

aWaveformX[0]=aAnalogXf[StartPoint];
aWaveformY[0]=aAnalogYf[StartPoint];
for(i=1; i<N; i++)
{

j=DivPeriod*i;
aWaveformX[i]= aAnalogXf[StartPoint + (int)(j/1000.) ] + (int)

((aAnalogXf[StartPoint + (int) (j/1000.)+1] - aAnalogXf[StartPoint + (int)
(j/1000.)]) * (j%1000)/1000.);

aWaveformY[i]=aAnalogYf[StartPoint + (int)(j/1000.)] + (int)

((aAnalogYf[StartPoint+ (int) (j/1000.)+1] - aAnalogYf[StartPoint + (int)
(j/1000.)]) * (j%1000)/1000.);

}

Here, N denotes the sampling rate, that is, a resolution, DivPeriod is a value of a period divided by N, and aAnalogXf and aAnalogYf are output signals of X and Y channels of the encoder, which have been passed through the low pass filter.

aWaveformX and aWaveformY denote encoder patterns having a [1×N] dimension.

After the encoder patterns are generated as described above, aWaveformX and aWaveformY are output (S590).

As illustrated in FIG. 5, in the generation process of an analog encoder pattern, predetermined characteristic values are extracted from the output signal of the analog encoder and the period and the start position are calculated using the extracted characteristic values. Accordingly, an encoder pattern adapted to characteristic values of an analog encoder being used can be obtained.

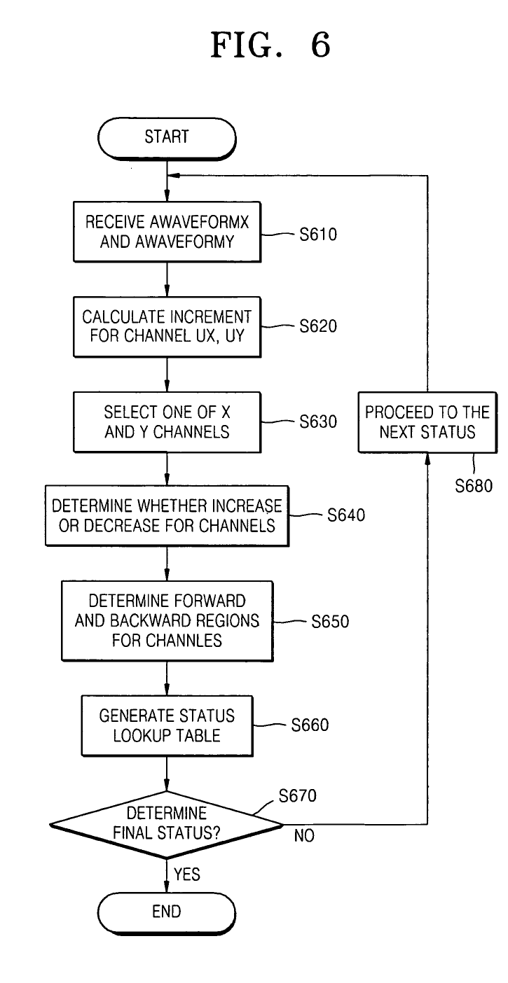

FIG. 6 is a flowchart illustrating a generation stage of a status lookup table included in a method of processing analog encoder signals, according to an exemplary embodiment of the present invention.

When the analog encoder pattern is generated as illustrated in FIG. 5, aWaveform X and aWaveformY which are the generated encoder patterns are received (S610).

For generation of a more precise lookup table, in the method of processing analog encoder signals according to an embodiment of the present invention, only an output value of the X or the Y channel corresponding to a linear region may be used. The reason why the status lookup table is generated using only the output value of the X or the Y channel corresponding to the linear region is that the output value changes rapidly in the linear region for any channel. For example, of the output values of the X channel, in the region corresponding to a value in proximity with the maximal value or the minimal value of the X channel, there is a small change in the output value.

Accordingly, uX and uY which are respective increments of the output signals of the X and Y channels are calculated respectively for selecting a channel value corresponding to the liner region (S620). The uX and uY may be calculated as below.
uX=aWaveformX[i+1]−aWaveformX[i];
uY=aWaveformY[i+1]−aWaveformY[i]

Here, i is an index of the encoder pattern.

After the increments of the output signals of the channels are calculated, respectively, the region of the output signals to be used for generation of the status lookup table is calculated as illustrated in Table 3.

TABLE 3

| REGION CLASSIFICATION | | CLASSIFICATION METHOD |
|---|---|---|
| X USAGE | UP REGION | (abs(uX)>abs(uY)) && (uX>0) |
| REGION | DOWN REGION | (abs(uX)>abs(uY)) && (uX<=0) |
| Y USAGE | UP REGION | (abs(uX)<=abs(uY)) && (uY>0) |
| REGION | DOWN REGION | (abs(uX)<=abs(uY)) && (uY<=0) |

As illustrated in Table 3, a region in which the output signal of the X channel is used is a region in which the increment of X is larger than the increment of Y, and a region in which the output signal of the Y channel is used is a region in which the increment of Y is larger than the increment of X (S630). It is then checked whether an output signal of each of the X and Y channels is increasing or decreasing (S640) to determine whether the region is an up region or a down region. In other words, regions are classified into Up regions and Down regions according to whether the increment is greater or less than 0.

Referring to FIG. 7, the regions in which X is used are a region <I> starting at position 0 and ending at position 3 and a region <III> starting at position 8 and ending at position b. On the other hand, the regions in which Y is used are a region <II> starting at position 4 and ending at position 7 and a region <IV> starting at position c and ending at position f. In addition, if the regions are classified according to whether the increment is greater or less than 0, the regions <I> and <II> are Up regions in which output signals of the X and Y channels are increasing respectively, and the regions <III> and <IV> are Down regions in which the output signals of the X and Y channels are decreasing, respectively.

The encoder pattern can be generated precisely by extracting the linear region from the output signal and using the region as described above.

Thereafter, forward regions and backward regions are determined for the X and Y channels, respectively (S650). A change in an output status will now be described with reference to TABLE 4.

TABLE 4

| REGION | | OUTPUT | XUP, | |
|---|---|---|---|---|
| CLASSIFICATION | | STATUS | YUP | |
| X | UP | CURRENT | D, D | IGNORE YUP SIGNAL |
| USAGE | REGION | STATUS −1 | | WHEN XUP IS U, |
| REGION | | CURRENT | U, D | FORWARD TO THE |
| | | STATUS +1 | | NEXT STATUS. WHEN |
| | | CURRENT | D, U | XUP IS D, BACKWARD |
| | | STATUS −1 | | |
| | | CURRENT | U, U | |
| | | STATUS +1 | | |
| | DOWN | CURRENT | D, D | IGNORE YUP SIGNAL |
| | REGION | STATUS +1 | | WHEN XUP IS U, |
| | | CURRENT | U, D | BACKWARD TO THE |
| | | STATUS −1 | | PREVIOUS STATUS. |
| | | CURRENT | D, U | WHEN XUP IS D, |
| | | STATUS +1 | | BACKWARD |
| | | CURRENT | U, U | |
| | | STATUS −1 | | |
| Y | UP | CURRENT | D, D | IGNORE XUP SIGNAL |
| USAGE | REGION | STATUS −1 | | WHEN YUP IS D, |
| REGION | | CURRENT | U, D | BACKWARD TO THE |
| | | STATUS −1 | | PREVIOUS STATUS. |
| | | CURRENT | D, U | WHEN YUP IS U, |
| | | STATUS +1 | | FORWARD. |
| | | CURRENT | U, U | |
| | | STATUS +1 | | |
| | DOWN | CURRENT | D, D | IGNORE XUP SIGNAL |
| | REGION | STATUS +1 | | WHEN YUP IS D, |
| | | CURRENT | U, D | FORWARD TO THE |
| | | STATUS +1 | | NEXT STATTUS. WHEN |
| | | CURRENT | D, U | XUP IS U, BACKWARD |
| | | STATUS −1 | | |
| | | CURRENT | U, U | |
| | | STATUS −1 | | |

For convenience of description, an Xup signal and a Yup signal are represented as D when the Xup and Yup signals are 0, and the Xup and Yup signals are represented as U when the Xup and Yup signals are 1, respectively.

Table 4 will now be described with reference to FIG. 7.

First, the region <I> which is an X usage region and an Up region will be described. In this case, it is assumed that the current position is located at position 1. This assumption is only for purposes of description and the present invention is not limited thereto.

When the current position is located at position 1, if (Xup, Yup) signals are (D,D) or (D,U), the encoder is moved backward to the previous status of the current status based on the Xup signal regardless of the Yup signal. Accordingly, the encoder is moved backward to a position 0. When (Xup, Yup) signals are (U,D) or (U,U), the encoder is moved forward to the next status of the current status based on the Xup signal regardless of the Yup signal.

Next, the <II> region which is a Y usage region and an Up region will be described.

When the current position is located at position 5, if (Xup,Yup) signals are (D,D) or (U,D), the encoder is moved backward to the previous status based on the Yup signal regardless of the Xup signal. Accordingly, the encoder is moved backward to position 4. If (Xup,Yup) signals are (D,U) or (U,U), the encoder is moved forward to the next status based on the Yup signal regardless of the Xup signal.

Using the same method, the status lookup table is filled for regions <III> and <IV> (S660).

An example of the status lookup table generated using the method described above is shown in FIG. 8.

The graphs in FIG. 7 and the lookup table in FIG. 8 are for exemplary purposes only and are not intended to limit the present invention.

Accordingly, it is determined whether the last position of the status lookup table is filled out or not (S670). When the status lookup table has not been fully generated, the operations described above are repeated (S680).

FIG. 8 is a status lookup table according to an embodiment of the present invention.

In FIG. 8, a region from position 0 to position 3 is a region in which X is used and corresponds to the region <I> in FIG. 7. Accordingly, the statuses are changed based on the Xup signal regardless of the Yup signal, respectively. For example, if (Xup, Yup) signals are (D,D) in a status of position 2, the encoder is moved backward to a previous position based on the Xup signal. Accordingly, the encoder is moved backward to position 1. In addition, if (Xup, Yup) signals are (U,D) in a status of position 3, the encoder is moved forward to the next status based on the Xup signal. Accordingly, the encoder is moved forward to position 4. Using this method, all elements of the status lookup table shown in FIG. 8 are determined.

In this case, values of output signals of the analog encoder cannot be classified sufficiently if N=4. Accordingly, it may be difficult to calculate values of uX and uY properly, so a status lookup table such as TABLE 5 below may be used.

TABLE 5

| STATUS | DD | UD | DU | UU |
|---|---|---|---|---|
| 0 | 3 | 1 | 3 | 1 |
| 1 | 0 | 0 | 2 | 2 |
| 2 | 3 | 1 | 3 | 1 |
| 3 | 0 | 0 | 2 | 2 |

As described above, after the pattern generation of the analog encoder and the generation of the status lookup table are completed, a feedback output signal is compared to the status information, and the quadrature signals are generated based on the comparison result.

In addition, the method for processing analog encoder signals may further include storing the generated encoder pattern and outputting a pattern value of the analog encoder corresponding to the latest status. Then, the status information on the positional change is generated by comparing a value of the analog encoder pattern to the output signal of the analog encoder, and the predictive current status is determined using the status information based on the status information on the positional change and the latest status using the method described above.

In an exemplary method of processing analog encoder signals, the pattern of the analog encoder may be generated when the apparatus for processing the analog encoder signals is initialized.

The determination process of the latest status and the predictive current status that is status information on the next position may include a digital-to-analog conversion stage, a generation stage of status information on positional change, and a determining stage of predictive current status. The stages will now be described in detail.

First, in the digital-to-analog conversion stage, when the status information is input from the latch unit 350 in FIG. 3, the signal stored in the pattern storage unit 320 of the analog encoder 300 is converted to an analog value.

In the generation stage of the status information on the positional change, the comparison unit 340 in FIG. 3 compares the signals output from the digital-to-analog converter 330 to the first and second signals 301 and 302, that are pseudo sine waves, output from the analog encoder 300, respectively, and outputs the comparison result in the form of 1s or “0s. More specifically, the first comparison unit 341 generates the status information on the positional change, Xup 342, and the second comparison unit 343 generates the status information on the positional change, Yup 344.

The status information on the positional change is contained in the digital signals Xup 342 and Yup 344 which are output from the comparison unit 340. The digital signal Xup 342 contains the positional change for the first signal 301 and the digital signal Yup 344 contains the positional change for the second signal 302.

Thereafter, in the determination stage of the predictive current status, the determination unit 360 in FIG. 3, receives the status information on the positional changes contained in the digital signals Xup 342 and Yup 344 and determines the predictive current status with reference to the status lookup table as shown in FIG. 8.

The gray code conversion unit 370 receives the predictive current status 362 from the determination unit 360, converts the predictive current status 362 into a gray code, and generates quadrature signals using the converted gray code. For the generation of the quadrature signals, in the gray code conversion unit 370, a gray code lookup table (not shown) which predetermines a relationship between the gray code and the quadrature signals may be stored as described above.

The positional information (PI) according to an exemplary embodiment of the present invention includes information on a status of statuses according to exemplary embodiment of the present invention to which a current position of an axis of the motor corresponds. This positional information indicates a status value of the latest status or the predictive current state. Although one period is divided into 16 regions for purposes of description as described above, it will be understood by those skilled in the art that more precise positional information can be obtained by dividing one period into a greater number regions.

As described above, according to an exemplary embodiment of the present invention, quadrature signals for controlling a motor can be generated or positional information can be obtained by sampling pseudo sine wave output signals which have been output from an analog encoder at certain intervals and comparing the sampled signals to the output signals of the analog encoder, and determining a predictive current status that is the next status based on the latest status.

In addition, the generation of quadrature signals or obtaining the positional information may be performed without using an analog-to-digital converter which is used in the conventional art.

In addition, the motor may be controlled stably regardless of characteristics of the analog encoder by automatically generating a pattern of the encoder and a status lookup table corresponding to various characteristics of the analog encoder. In an exemplary implementation, the encoder pattern and the status lookup table can be generated automatically corresponding to a resolution which is selected by a user.

Furthermore, a computer readable medium can be provided for storing thereon a plurality of computer executable instructions for processing signals and generating quadrature signals to control a motor using output signals of an analog encoder comprising at least one channel. The instructions may incorporate the methodology for processing signals and generating quadrature signals to control a motor as described above with reference to certain exemplary embodiments of the present invention.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An apparatus for processing an analog encoder signal and generating quadrature signals for controlling rotation of a motor comprising:
a pattern generation unit for receiving an output signal of an analog encoder comprising at least one channel, generating an encoder pattern corresponding to a waveform of the output signal and sampling the received output signal at predetermined intervals; and
a generation unit for receiving the encoder pattern and generating a status lookup table comprising status information on at least one status based on the received encoder pattern;
wherein the quadrature signals are generated by comparing feedback output signals to the status information.

2. The apparatus of claim 1, wherein the apparatus further comprises:
a latch unit for storing a latest status;
a determination unit for determining a current status;
a pattern storage unit for storing the encoder pattern received from the generation unit and outputting a pattern value of the analog encoder corresponding to latest status information received from the latch unit; and
a comparison unit for generating status information on positional change by comparing the pattern value of the analog encoder to the output signal of the analog encoder;
wherein the latch unit sets the latest status to a predictive current status transferred from the determination unit for determining the current status according to a reference clock; and
the determination unit determines the predictive current status using the status information based on the status information on positional change and the latest status information.

3. The apparatus of claim 2, wherein the apparatus further comprises a digital-to-analog converter for converting an output of the pattern storage unit into an analog signal and transferring the converted analog signal to the comparison unit.

4. The apparatus of claim 2, wherein the pattern generation unit comprises:
a characteristic value extraction unit for extracting characteristic values comprising a maximal value and a minimal value and calculating a median value using the extracted maximal and minimal values;
a period calculation unit for calculating a period of the output signal using the characteristic values; and
a start position extraction unit extracting a start position of a period using the characteristic values;
wherein the encoder pattern is generated by sampling a waveform corresponding to one period from the start position at a sampling rate.

5. The apparatus of claim 4, wherein:
the period calculation unit sequentially extracts a first position which has a smaller value than the median value, a second position which has a value equal to or greater than the median value, a third position which has a value smaller than the median value, and a fourth position which has a value equal to or greater than the median value; and
one period is determined to be from the second position to the fourth position.

6. The apparatus of claim 4, wherein the start position extraction unit has the output signals corresponding to the channels smaller than the median value, and the start position is determined to be a position having a minimal difference value of the output signals.

7. The apparatus of claim 2, wherein the apparatus further comprises a driving signal conversion unit for converting the predictive current status or the latest status into the quadrature signals, wherein the driving signal conversion unit comprises a gray code conversion unit for converting at least one of the predictive current status and the latest state into a gray code and generating the quadrature signals.

8. The apparatus of claim 2, wherein
the status lookup table represents a relationship between the driving signal and at least one of the predictive current status and the latest status, and
the quadrature signals are generated using the status lookup table.

9. The apparatus of claim 3, wherein the digital-to-analog converter comprises:
a first converter for converting a first pseudo sine wave output signal input from the pattern storage unit into a first analog signal; and
a second converter for converting a second pseudo sine wave output signal input from the pattern storage unit into a second analog signal.

10. The apparatus of claim 9, wherein the comparison unit comprises:
a first comparison unit for comparing a first pseudo sinusoidal output signal from the first converter with an output signal of a first channel of the analog encoder; and
a second comparison unit for comparing a second pseudo sinusoidal output signal from the second converter with an output signal of a second channel of the analog encoder.

11. A method of processing signals and generating quadrature signals to control a motor using output signals of an analog encoder comprising at least one channel, the method comprising:
generating an encoder pattern of an analog encoder by receiving an output signal of the analog encoder and sampling the output signal;
receiving the encoder pattern and generating a status lookup table comprising at least one information item of the analog encoder; and
generating quadrature signals by comparing the feedback output signal to the status information.

12. The method of claim 11, further comprising:
storing the encoder pattern and outputting a pattern value of the analog encoder corresponding to a latest status of the analog encoder;
generating status information on positional change by comparing the pattern value of the analog encoder to the output signal of the analog encoder;
latching a predictive current status and setting the latest status to a predictive current status according to a reference clock; and
determining the predictive current status using the status information based on the status information on positional change and the latest status.

13. The method of claim 11, wherein the generating of the quadrature signals comprises:
extracting characteristic values comprising maximal and minimal values of the output signal and calculating a median value using the extracted maximal and minimal values;
calculating a period of the output signal using the characteristic values; and
extracting a start position of a period using the characteristic values;
wherein generating the encoder pattern comprises sampling a period of a waveform starting from the start position.

14. The method of claim 13, wherein the calculating of the period of the output signal comprises:
sequentially extracting a first position which has a smaller value than the median value, a second position which has a value equal to or greater than the median value, a third position which has a value smaller than the median value, and a fourth position which has a value equal to or greater than the median value, and
determining from the first position to the fourth position to be one period.

15. The method of claim 13, wherein in the extracting of the start position of the period,
the output signals corresponding to the channels have values smaller than the median value, and the start position is determined to be a position having a minimal difference value of the output signals.

16. The method of claim 11, wherein the receiving of the encoder pattern and the generating of the status lookup table comprises:
converting the analog encoder pattern into an analog signal;
generating status information on positional change by comparing the converted analog signal and a pseudo sine wave output signal of the analog encoder; and
determining the predictive current status which is the next status based on the generated status information on the positional change and the latest status of the analog encoder.

17. The method of claim 11, wherein:
the status lookup table indicates a relationship between the driving signal and at least one of the predictive current status and the latest status, and
the quadrature signals are generated using the status lookup table.

18. The apparatus of claim 1, wherein the generation unit generate the status lookup table comprising information on a plurality of statuses based on the received encoder pattern.

19. The apparatus of claim 18, wherein the plurality of statuses comprises a predetermined number of statuses.

20. The method of claim 11, wherein the sampling of the output signal comprises sampling the output signal at a predetermined sampling rate.

21. The method of claim 11, wherein the receiving of the encoder pattern and the generating of the status lookup table comprises generating a status lookup table comprising a predetermined number of information items of the analog encoder.

22. An apparatus for processing an analog encoder signal and generating quadrature signals for controlling rotation of a motor comprising:
means for receiving an output signal of an analog encoder comprising at least one channel, for generating an encoder pattern corresponding to a waveform of the output signal, and for sampling the received output signal at predetermined intervals; and
means for receiving the encoder pattern and generating a status lookup table comprising status information on at least one status based on the received encoder pattern;
wherein the quadrature signals are generated by comparing feedback output signals to the status information.

23. The apparatus of claim 22, wherein the apparatus further comprises:
means for storing a latest status;
means for determining a current status;
means for storing the encoder pattern received from the means for receiving the encoder pattern and generating the status lookup table, and for outputting a pattern value of the analog encoder corresponding to latest status information received from the means for storing a latest status; and
means for generating status information on positional change by comparing the pattern value of the analog encoder to the output signal of the analog encoder;
wherein the means for storing a latest status sets the latest status to a predictive current status transferred from the means for determining the current status according to a reference clock; and
the means for determining the current status determines the predictive current status using the status information based on the status information on positional change and the latest status information.

24. The apparatus of claim 23, wherein the apparatus further comprises means for converting an output of the means for storing the encoder pattern into an analog signal and transferring the converted analog signal to the means for generating the status information.

25. The apparatus of claim 23, wherein means for receiving the output signal comprises:
means for extracting characteristic values comprising a maximal value and a minimal value and calculating a median value using the extracted maximal and minimal values;
means for calculating a period of the output signal using the characteristic values; and
means for extracting a start position of a period using the characteristic values;
wherein the encoder pattern is generated by sampling a waveform corresponding to one period from the start position at a sampling rate.

26. The apparatus of claim 23, wherein the apparatus further comprises means for converting the predictive current status or the latest status into the quadrature signals, the means for converting comprising means for converting at least one of the predictive current status and the latest state into a gray code and generating the quadrature signals.

27. The apparatus of claim 23, wherein
the status lookup table represents a relationship between the driving signal and at least one of the predictive current status and the latest status, and
the quadrature signals are generated using the status lookup table.

28. A computer readable medium for storing thereon a plurality of computer executable instructions comprising instructions for processing signals and generating quadrature signals to control a motor using output signals of an analog encoder comprising at least one channel, the computer executable instructions comprising:
a first set of instructions for generating an encoder pattern of an analog encoder by receiving an output signal of the analog encoder and sampling the output signal;
a second set of instructions for receiving the encoder pattern and generating a status lookup table comprising at least one information item of the analog encoder; and
a third set of instructions for generating quadrature signals by comparing the feedback output signal to the status information.

29. The computer readable medium of claim 28, wherein the computer executable instructions further comprise:
a fourth set of instructions for storing the encoder pattern and outputting a pattern value of the analog encoder corresponding to a latest status of the analog encoder;
a fifth set of instructions for generating status information on positional change by comparing the pattern value of the analog encoder to the output signal of the analog encoder;
a sixths set of instructions for latching a predictive current status and setting the latest status to a predictive current status according to a reference clock; and
a seventh set of instructions for determining the predictive current status using the status information based on the status information on positional change and the latest status.

30. The computer readable medium of claim 28, wherein the third set of instructions comprises instructions for:
extracting characteristic values comprising maximal and minimal values of the output signal and calculating a median value using the extracted maximal and minimal values;
calculating a period of the output signal using the characteristic values; and
extracting a start position of a period using the characteristic values;
wherein generating the encoder pattern comprises sampling a period of a waveform starting from the start position.

31. The computer readable medium of claim 30, wherein the instructions for calculating of the period of the output signal comprise instructions for:
sequentially extracting a first position which has a smaller value than the median value, a second position which has a value equal to or greater than the median value, a third position which has a value smaller than the median value, and a fourth position which has a value equal to or greater than the median value, and
determining from the first position to the fourth position to be one period.

32. The computer readable medium of claim 30, wherein in the instructions for extracting of the start position of the period,
the output signals corresponding to the channels have values smaller than the median value, and the start position is determined to be a position having a minimal difference value of the output signals.

33. The computer readable medium of claim 28, wherein the second set of instruction comprises instructions for:
converting the analog encoder pattern into an analog signal;
generating status information on positional change by comparing the converted analog signal and a pseudo sine wave output signal of the analog encoder; and
determining the predictive current status which is the next status based on the generated status information on the positional change and the latest status of the analog encoder.

34. The computer readable medium of claim 28, wherein:
the status lookup table indicates a relationship between the driving signal and at least one of the predictive current status and the latest status, and
the quadrature signals are generated using the status lookup table.
